(19) United States
(12) Patent Application Publication
(10) Pub. No.: US 2025/0224613 A1
(43) Pub. Date: Jul. 10, 2025

(54) WEARABLE DISPLAY DEVICE AND ADJUSTMENT METHOD THEREOF

(71) Applicant: Coretronic Corporation, Hsin-Chu (TW)

(72) Inventors: Yen-Ting Lin, Hsin-Chu (TW); Wei-Min Chien, Hsin-Chu (TW)

(73) Assignee: Coretronic Corporation, Hsin-Chu (TW)

(21) Appl. No.: 19/015,499

(22) Filed: Jan. 9, 2025

(30) Foreign Application Priority Data
Jan. 9, 2024 (CN) 202410028648.3

(51) Int. Cl. G02B 27/01; G09G 3/00

(52) U.S. Cl. CPC G02B 27/0172; G09G 3/002; G02B 2027/0112; G02B 2207/101; G09G 2320/0646

(57) ABSTRACT

An adjustment method of a wearable display device includes steps of providing a display light beam to a light transmitting element to form an image, sensing an intensity of an ambient light to obtain a light intensity signal, and adjusting a brightness of the display light beam and/or a transmittance of the light transmitting element according to the light intensity signal. The adjustment method maintains good display effect of the wearable display device and improve user experience.

### CROSS-REFERENCE TO RELATED APPLICATION

This application claims the priority benefit of China application serial no. 202410028648.3, filed on Jan. 9, 2024. The entirety of the above-mentioned patent application is hereby incorporated by reference herein and made a part of this specification.

### BACKGROUND

### Technical Field

The disclosure relates to an electronic device, and in particular to a wearable display device and an adjustment method thereof.

### Description of Related Art

The near eye display (NED) and the head-mounted display (HMD) are next-generation killer products with great development potential. Related applications of near-eye display technology may currently be divided into augmented reality (AR) technology and virtual reality (VR) technology. For the augmented reality technology, developers in relevant fields are currently working on how to provide the optimal image quality while the devices being light and thin. However, in augmented reality display technology, the surrounding brightness has a great impact on user experience. Specifically, if the brightness of the image provided by augmented reality or virtual reality device remains unchanged and the surrounding brightness gets higher, the pupils of the human eyes shrink to avoid too much light entering the eyes, and the image may be too dim to be seen clearly. If the surrounding brightness gets dimmer, the pupils of the human eyes dilate, the image may be too bright for the eyes. Therefore, establishing a method to reduce the impact of the surrounding brightness on the user experience is one of the current important topics.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a wearable display device and an adjustment method thereof, which can maintain a good display effect of the wearable display device by automatically adjusting a transmittance of a light transmitting element or a power of a display module to improve user experience quality.

Other objectives and advantages of the disclosure may be further understood from the technical features disclosed in the disclosure.

In order to achieve one, a part, or all of the above objectives or other objectives, the disclosure provides an adjustment method of a wearable display device, including a step of providing a display light beam to a light transmitting element for imaging; a step of sensing an intensity of an ambient light to obtain a light intensity signal; and a step of adjusting a brightness of the display light beam and/or a transmittance of the light transmitting element according to the light intensity signal.

In order to achieve one, a part, or all of the above objectives or other objectives, the disclosure provides a wearable display device, including a frame body, a light transmitting element, a display module, an optical sensing module, and a control unit. The light transmitting element is disposed on the frame body. The display module is disposed on the frame body and is configured to provide a display light beam to the light transmitting element to form an image. The optical sensing module is disposed on a side of the light transmitting element and is configured to sense an intensity of an ambient light passing through the light transmitting element to obtain a light intensity signal. The control unit is electrically connected to the display module and the optical sensing module. The control unit is configured to adjust a brightness of the display light beam according to the light intensity signal.

Based on the above, the embodiments of the disclosure have at least one of the following advantages or effects. In the wearable display device and the adjustment method thereof of the disclosure, the optical sensing module is disposed on a side of the light transmitting element and is configured to sense the intensity of the ambient light passing through the light transmitting element to obtain the light intensity signal. Also, the control unit adjusts the brightness of the display light beam and/or the transmittance of the light transmitting element according to the light intensity signal. As a result, the transmittance of the light transmitting element and/or the power of the display module may be automatically adjusted to maintain a good display effect of the wearable display device and improve the user experience quality.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of a wearable display device according to an embodiment of the disclosure.

FIG. 2 is a schematic front view of the wearable display device of FIG. 1 according to the disclosure.

FIG. 3 is a schematic front view of a wearable display device according to another embodiment of the disclosure.

FIG. 4A and FIG. 4B are respectively a schematic top view and a schematic side view of a wearable display device according to another embodiment of the disclosure.

FIG. 5A and FIG. 5B are respectively a schematic top view and a schematic side view of a wearable display device according to another embodiment of the disclosure.

FIG. 6 is a schematic flowchart of steps of an adjustment method of a wearable display device according to an embodiment of the disclosure.

FIG. 7 is a schematic flowchart of detailed steps of the adjustment method of FIG. 6 according to an embodiment.

FIG. 8 is a schematic flowchart of detailed steps of the adjustment method of FIG. 6 according to another embodiment.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings.

Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

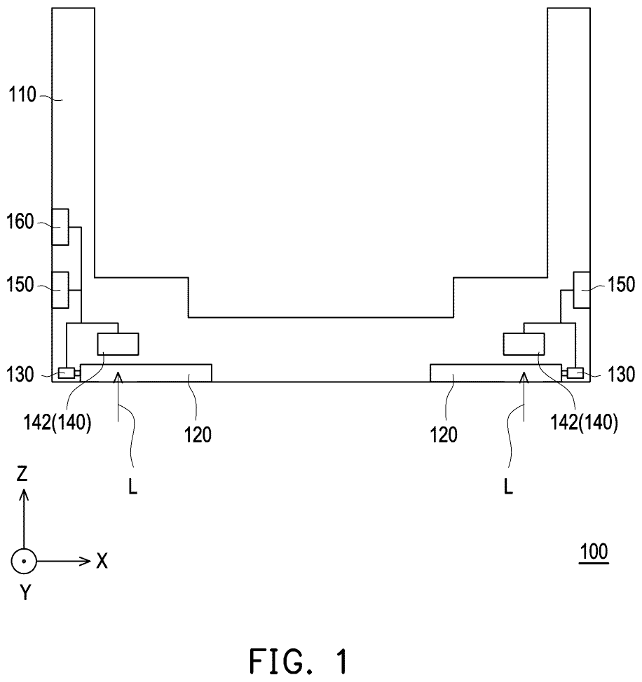

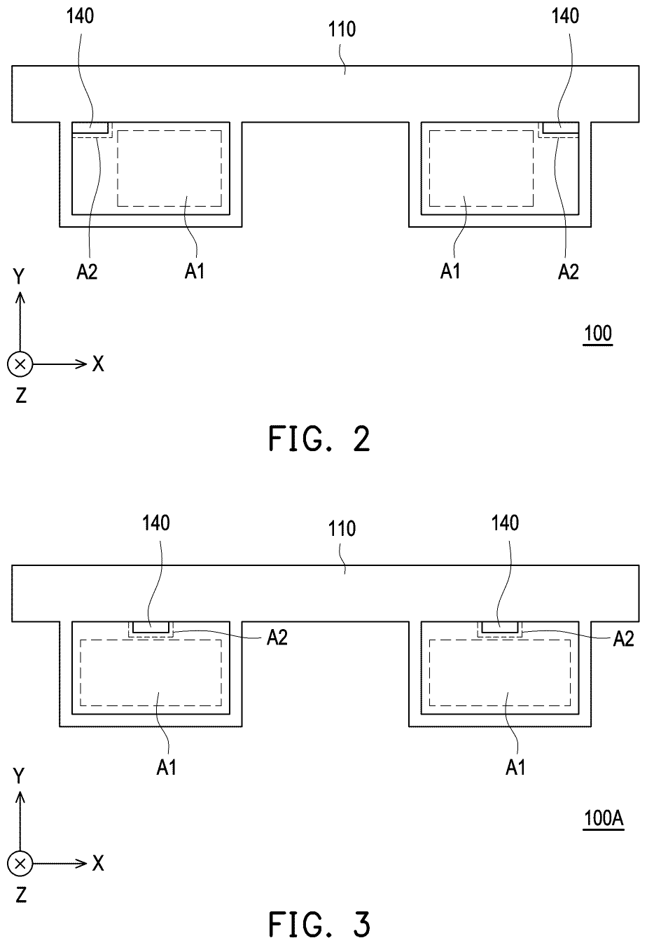

FIG. 1 is a schematic top view of a wearable display device according to an embodiment of the disclosure. FIG. 2 is a schematic front view of the wearable display device of FIG. 1 according to the disclosure. Please refer to FIG. 1 and FIG. 2. The embodiment provides a wearable display device 100 including a frame body 110, a light transmitting element 120, a display module 130, an optical sensing module 140, and a control unit 150. The frame body 110 is, for example, a spectacle frame. The display module 130 is disposed on the frame body 110 and is configured to provide a display light beam to the light transmitting element 120 to form an image, so that a user may observe the image in conjunction with physical objects in the environment when wearing the wearable display device 100, thereby implementing augmented reality (AR) or mixed reality (MR). The display module 130 includes, for example, light source elements (for example, light emitting diodes, laser diodes, or other light emitting elements), an image generating element (for example, a light valve or a display panel), and a lens element.

The light transmitting element 120 is disposed on the frame body 110. The light transmitting element 120 includes, for example, a photochromism lens or an electrochromism lens. For example, a substance in the photochromism lens enables the dimming value of the lens to change in response to the intensity of light irradiating the lens. For example, the electrochromism lens changes the dimming value of the lens in response to a voltage applied to electrodes of the lens. When the light transmitting element 120 includes the electrochromism lens, the dimming value may be further adjusted by electrical control, such as by adjusting the transmittance, that is, the grayscale level, but not limited thereto. For example, when the transmittance needs to be increased, the dimming value of the light transmitting element 120 may be reduced by electrical adjustment to increase the transmittance. When the transmittance needs to be reduced, the dimming value of the light transmitting element 120 may be increased by electrical adjustment to reduce the transmittance. The light transmitting element 120 has an image forming area A1 and a sensing light incident area A2. The display light beam (not shown) from the display module 130 is transmitted to the image forming area A1 for forming the image. The optical sensing module 140 is configured to receive an ambient light L passing through the sensing light incident area A2. The image forming area A1 and the sensing light incident area A2 do not overlap. In the embodiment, the sensing light incident area A2 may be designed to be located on one of two opposite sides of the image forming area A1 in the horizontal direction. In other embodiments, the sensing light incident area A2 may be designed to be located on one of two opposite sides of the image forming area A1 in the vertical direction, such as a wearable display device 100A shown in FIG. 3, but the disclosure is not limited thereto. Specifically, the light transmitting element 120 is, for example, a photochromism lens, an electrochromism lens, a combination of a photochromism lens and a light transmitting lens, or a combination of an electrochromism lens and a light transmitting lens.

The optical sensing module 140 is disposed on a side of the light transmitting element 120, includes, for example, a light sensing element 142, and is configured to sense the intensity of the ambient light L passing through the light transmitting element 120 to obtain a light intensity signal Lₛ. Specifically, the optical sensing module 140 and the display module 130 are disposed on the same side of the light transmitting element 120.

The control unit 150 is electrically connected to the display module 130 and the optical sensing module 140. The control unit 150 includes, for example, a central processing unit (CPU), a microprocessor, a digital signal processor (DSP), a programmable controller, a programmable logic device (PLD), or other similar devices, or a combination of these devices, but the disclosure is not limited thereto. The control unit 150 is configured to adjust the brightness of the display light beam (such as to increase or decrease the power supply of the light source element of the display module 130) according to the light intensity signal Lₛ sensed by the optical sensing module 140. When the light transmitting element 120 includes an electrochromism lens, the control unit 150 may further adjust the dimming value of the light transmitting element 120 by electrical control. In this way, the dimming value of the light transmitting element 120 or the power of the display module 130 may be automatically adjusted to maintain a good display effect of the wearable display device 100 and improve the user experience quality.

In addition, in the embodiment, the wearable display device 100 further includes a thermal sensing element 160 disposed on the frame body 110 and electrically connected to the control unit 150, and configured to sense the temperature of the display module 130 (for example, the temperature of the light source element of the display module 130) to obtain a temperature signal. The control unit 150 may be configured to decide whether to adjust the brightness of the display light beam (such as to increase or decrease the power supply of the light source element of the display module 130) according to the temperature signal. In this way, the wearable display device 100 may be maintained at an appropriate temperature to display images without overheating.

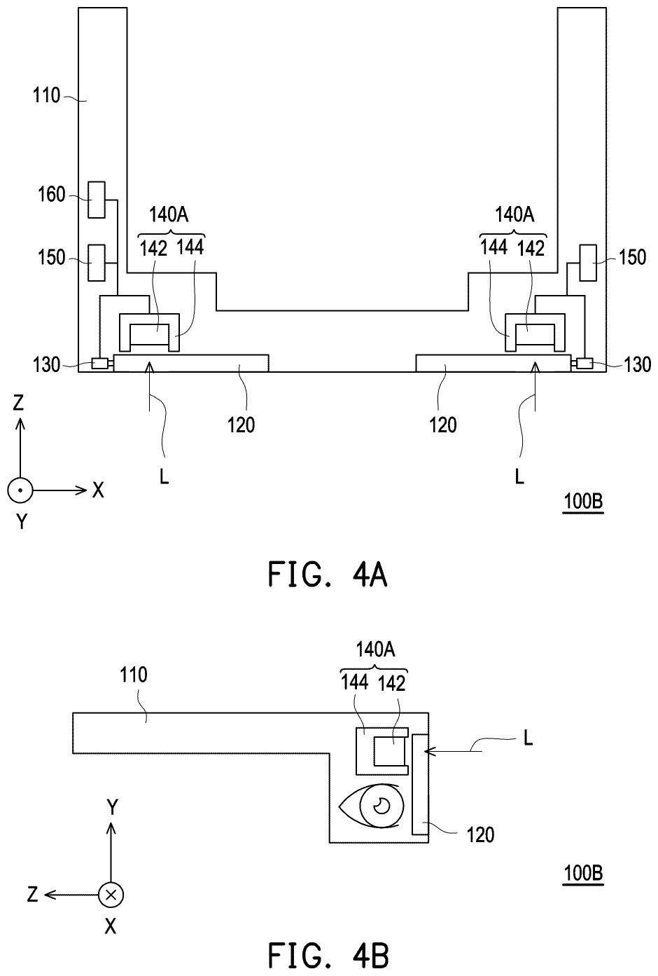

FIG. 4A and FIG. 4B are respectively a schematic top view and a schematic side view of a wearable display device according to another embodiment of the disclosure. Please refer to FIG. 4A and FIG. 4B. A wearable display device 100B shown in the embodiment is similar to the wearable display device 100 shown in FIG. 1. The difference between the two is that in the embodiment, an optical sensing module 140A also includes a light shielding member 144, and the light sensing element 142 is disposed in the light shielding member 144, so that the light shielding member 144 shields the light sensing element 142 to expose only the side facing the light transmitting element 120. In this way, stray light may be prevented from entering the optical sensing module 140A, thereby improving the sensing quality of the optical sensing module 140A.

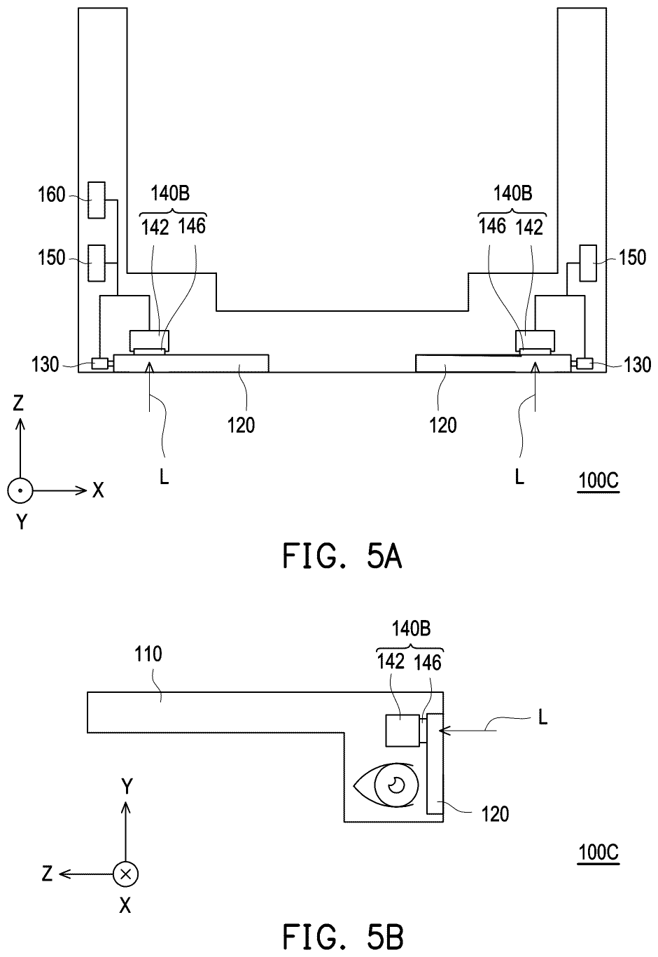

FIG. 5A and FIG. 5B are respectively a schematic top view and a schematic side view of a wearable display device according to another embodiment of the disclosure. Please refer to FIG. 5A and FIG. 5B. A wearable display device 100C shown in the embodiment is similar to the wearable display device 100 shown in FIG. 1. The difference between the two is that in the embodiment, the light sensing element 142 in an optical sensing module 140B has only one light emitting surface 146, and the light emitting surface 146 faces a side of the light transmitting element 120. In this way, stray light may be prevented from entering the optical sensing module 140B, thereby improving the sensing quality of the optical sensing module 140B.

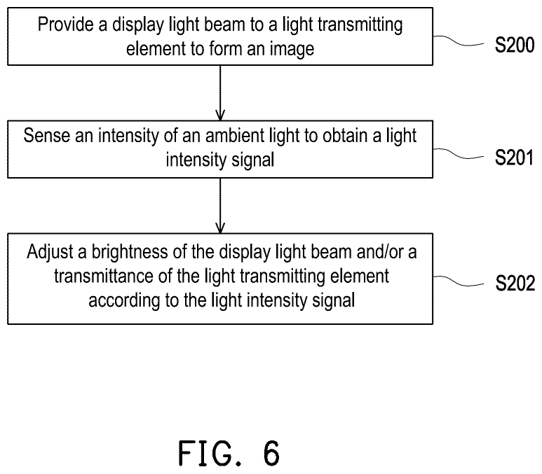

FIG. 6 is a schematic flowchart of steps of an adjustment method of a wearable display device according to an embodiment of the disclosure. Please refer to FIG. 1 and FIG. 6. The adjustment method provided by the embodiment may at least be applied to the wearable display device 100 shown in FIG. 1, so the following takes the embodiment of FIG. 1 as an example for further explanation. In the adjustment method of the wearable display device 100 of the embodiment, first, Step S200 is executed to provide the display light beam to the light transmitting element 120 for imaging. Next, Step S201 is executed to sense the intensity of the ambient light to obtain the light intensity signal Lₛ. Specifically, in the embodiment, the optical sensing module 140 receives the ambient light L passing through the sensing light incident area A2 of the light transmitting element 120 to obtain the light intensity signal Lₛ, so as to determine the display effect of the wearable display device 100. Finally, Step S202 is executed to adjust the brightness of the display light beam and/or the transmittance of the light transmitting element 120 according to the light intensity signal Lₛ. Specifically, in the embodiment, the control unit 150 adjusts the brightness of the display light beam (such as increasing or decreasing the power supply of the display module 130) according to the light intensity signal Lₛ, or the control unit 150 adjusts the dimming value (for example, the grayscale level, but not limited thereto) of the light transmitting element 120 according to the light intensity signal Lₛ.

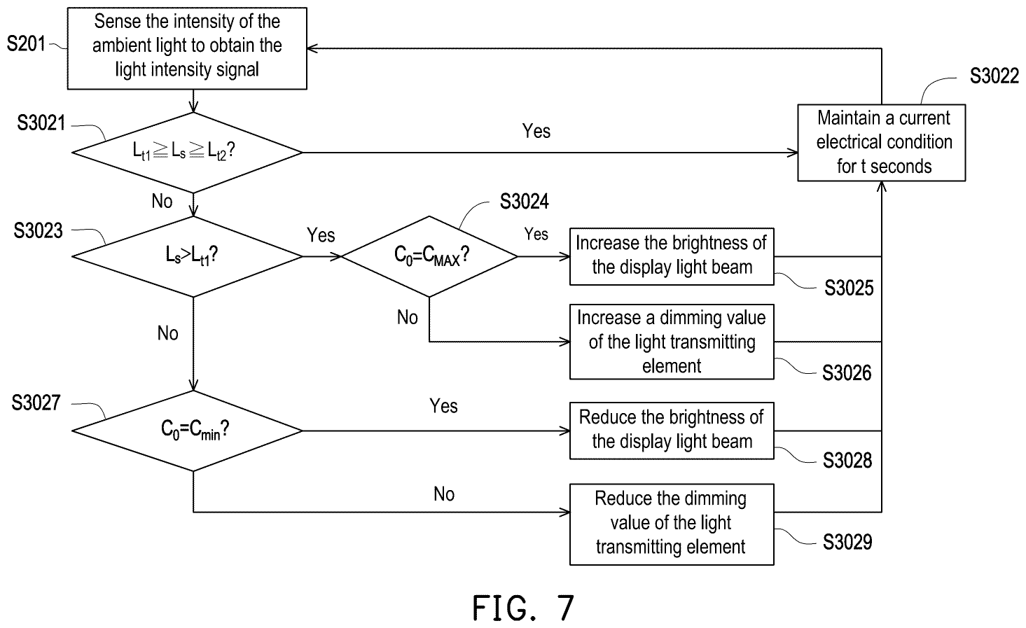

FIG. 7 is a schematic flowchart of detailed steps of the adjustment method of FIG. 6 according to an embodiment. Please refer to FIG. 1 and FIG. 7. The adjustment method provided by the embodiment may at least be applied to the wearable display device 100 shown in FIG. 1, so the following takes the embodiment of FIG. 1 as an example for further explanation. In an embodiment in which the light transmitting element 120 is an electrochromism lens, after executing Step S201 to sense the intensity of the ambient light L to obtain the light intensity signal Lₛ, such as in Step S202, first, Step S3021 is executed to determine whether the light intensity signal Lₛ is within a target range. The target range is, for example, an acceptable or comfortable brightness range for the human eyes, such as 300 nits to 600 nits, but not limited thereto. In other embodiments, the upper and lower limits of the target range, for example, may be different according to different display devices, or may be set by the user. For example, the control unit 150 may set the target range of the light intensity signal Lₛ in advance, or the target range may be stored in a storage unit of the wearable display device 100. When the light intensity signal is less than or equal to a target range maximum value (Lt) and greater than or equal to a target range minimum value (Lₜ₂), that is, Lₜ₁≥Lₛ≥Lₜ₂, Step S3022 is executed to maintain a current electrical condition (for example, the power of the display module 130 and/or the dimming value of the light transmitting element 120) for t seconds. The value of t may be designed according to different embodiment situations to reduce the frequency of determination and increase the service life of the wearable display device 100. After executing Step S3022, Step S201 may be executed again after t seconds, but not limited thereto.

Following the determination of Step S3021 above, when the light intensity signal Lₛ is not less than or equal to the target range maximum value Lu nor greater than or equal to the target range minimum value Lₜ₂, that is, Lₛ>Lₜ₁ or Lₛ<Lₜ₂, Step S3023 is executed to determine whether the light intensity signal Lₛ is greater than the target range maximum value Lₜ₁. When the light intensity signal Lₛ is greater than the target range maximum value Lₜ₁, that is, Lₛ>Lₜ₁, Step S3024 is executed to determine whether a dimming value (C₀) of the light transmitting element 120 is equal to a maximum dimming value (C_{MAX}) of the light transmitting element 120. Following Step S3024, when the dimming value of the light transmitting element 120 is equal to the maximum dimming value of the light transmitting element 120, that is, C₀=C_{MAX}, the light transmitting element 120 having minimum transmittance, Step S3025 is executed to increase the brightness of the display light beam (increase the power supply of the display module 130). Step S3022 is subsequently executed to maintain the current electrical condition for t seconds before performing subsequent automatic adjustment. Following Step S3024, when the dimming value of the light transmitting element 120 is not equal to (or less than) the maximum dimming value C_{MAX} of the light transmitting element 120, that is, C₀<C_{MAX}, Step S3026 is executed to increase the dimming value (increase the grayscale level) of the light transmitting element 120. Step S3022 is subsequently executed to maintain the current electrical condition for t seconds before performing subsequent automatic adjustment. Specifically, the dimming value C₀ is, for example, the current dimming value of the light transmitting element 120 (the adjusted dimming value of the light transmitting element 120) when executing Step S201, and is, for example, obtained by reading a setting value of the dimming value (C₀) of the optical element 120 with the control unit 150.

On the other hand, following Step S3023 above, when the light intensity signal Lₛ is not greater than the target range maximum value Lu, which means that the light intensity signal Lₛ is lower than the target range minimum value Lₜ₂, that is, Lₛ<Lₜ₂, Step S3027 is executed to determine whether the dimming value (C₀) of the light transmitting element 120 is equal to a minimum dimming value (Cₘᵢₙ) of the light transmitting element 120. When the dimming value of the light transmitting element 120 is equal to the minimum dimming value of the light transmitting element 120, that is, C₀=Cₘᵢₙ (the light transmitting element 120 having maximum transmittance), Step S3028 is executed to reduce the brightness of the display light beam (that is, to reduce the power supply of the display module 130). Step S3022 is subsequently executed to maintain the current electrical condition for t seconds before performing the subsequent automatic adjustment. Following the determination of Step S3027 above, when the dimming value of the light transmitting element 120 is not equal to the minimum dimming value of the light transmitting element 120, that is, C₀>Cₘᵢₙ, Step S3029 is executed to reduce the dimming value (that is, to reduce the grayscale level) of the light transmitting element 120. Step S3022 is subsequently executed to maintain the current electrical condition for t seconds before performing the subsequent automatic adjustment. In this way, the transmittance of the light transmitting element 120 or the power of the display module 130 may be automatically adjusted to maintain a good display effect of the wearable display device 100 and improve the user experience quality. In particular, in Step S3025 and Step S3028 of adjusting the brightness of the display light beam, the brightness of the display light beam may be adjusted according to a preset look-up table, for example, Table 1 below.

TABLE 1

| Light intensity signal Lₛ(nits) | Power W₀ (W) of display module |
|---|---|
| Lₛ ≤ 150 | 0.4 |
| 150 < Lₛ ≤ 300 | 0.7 |
| 300 < Lₛ ≤ 600 | 1.2 |
| 600 < Lₛ ≤ 1200 | 2 |
| Lₛ > 1200 | 3 |

For example, the target range of the light intensity signal Lₛ is 300 nits to 600 nits. When the measured light intensity signal Lₛ is 1100 nits and the light transmitting element 120 is already set to the maximum dimming value, the power W₀ (for example, the power supply for the light source element) provided to the display module 130 may be adjusted to 2 W according to the look-up table. When the measured light intensity signal Lₛ is 180 nits and the light transmitting element 120 is already set to the minimum dimming value, the power provided to the display module 130 may be adjusted to 0.7 W according to the look-up table.

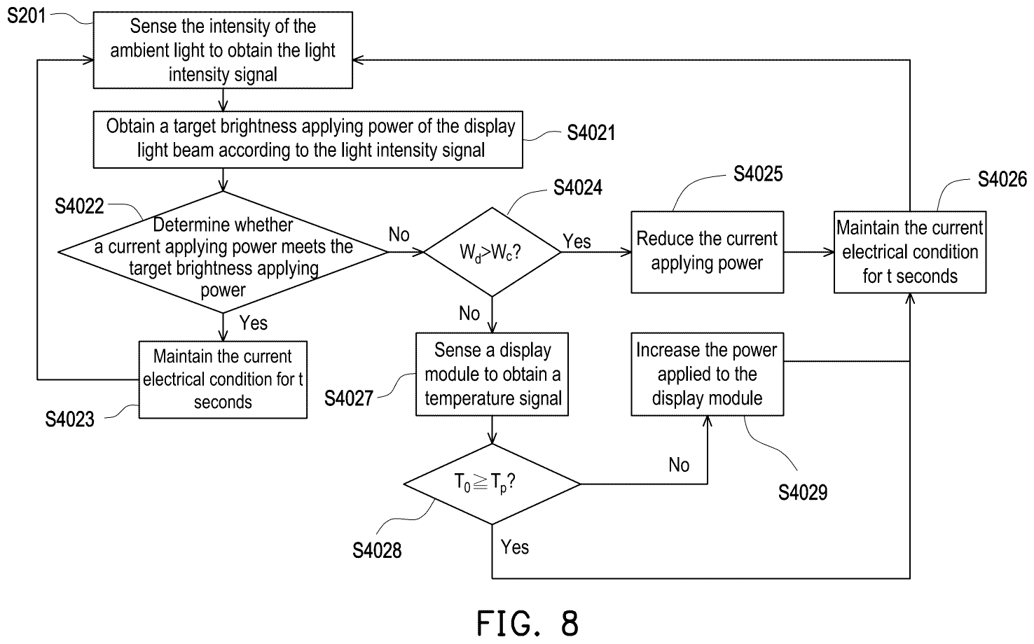

FIG. 8 is a schematic flowchart of detailed steps of the adjustment method of FIG. 6 according to another embodiment. Please refer to FIG. 1 and FIG. 8. The adjustment method provided by the embodiment may at least be applied to the wearable display device 100 shown in FIG. 1, so the following description takes the embodiment of FIG. 1 as an example for further explanation. In an embodiment in which the light transmitting element 120 is a photochromism lens, after executing Step S201 to sense the intensity of the ambient light L to obtain the light intensity signal Lₛ, such as in Step S202, first, Step S4021 is executed to obtain a target brightness applying power (W_{c}) of the display light beam according to the light intensity signal Lₛ. The target brightness applying power W_{c} is, for example, the power applied to the display module 130 (light source element) corresponding to an acceptable (comfortable) brightness for the human eyes under the intensity of the ambient light L corresponding to the light intensity signal Lₛ. The target brightness applying power We may be, for example, set by the user. For example, the control unit 150 may set the look-up table in advance in which the power of the display module 130 corresponds to the range of the light intensity signal Lₛ. See Table 1 above, the target brightness applying power We may be set according to the power W₀ of the display module. Next, Step S4022 is executed to determine whether a current applying power W_{d} provided to the display module 130 to generate a current display light beam meets the target brightness applying power W_{c}. When the current applying power W_{d} meets the target brightness applying power W_{c} (for example, W_{d}=W_{c}), Step S4023 is executed to maintain the current electrical condition for t seconds. The value of t may be designed according to different embodiment situations to reduce the frequency of determination process and increase the service life of the wearable display device 100. After executing Step S4024, Step S201 may be executed again after t seconds to perform the subsequent automatic adjustment.

Following Step S4022, when the current applying power W_{d} does not meet the target brightness applying power W_{c}, Step S4024 is executed to determine whether the current applying power W_{d} is greater than the target brightness applying power W_{d}. When the current applying power W_{d} is greater than the target brightness applying power W_{c}, that is, W_{d}>W_{c}, Step S4025 is executed to reduce the current applying power W_{d}. Afterward, Step S4026 is subsequently executed to maintain the current electrical condition for t seconds, and Step S201 is executed again, but not limited thereto. Following the determination of Step S4024 above, when the current applying power W_{d} is not greater than or equal to the target brightness applying power W_{c}, that is W_{d}<W_{c}, Step S4027 is executed to sense a temperature (T₀) of the display module 130 to obtain a temperature signal. Next, after Step S4027 above, Step S4028 is executed to determine whether the temperature (T₀) represented by the temperature signal is greater than or equal to a protection temperature value (Tₚ) of the display module 130. When the temperature T₀ of the display module 130 is not greater than or equal to the protection temperature value Tₚ of the display module 130, that is, T₀<Tₚ, Step S4029 is executed to increase the power (the current applying power W_{d}) applied to the display module 130. Afterward, Step S4026 is subsequently executed to maintain the current electrical condition for t seconds, and Step S201 is executed again, but not limited thereto. Following Step S4028, when the temperature T₀ of the display module 130 is greater than or equal to the protection temperature value Tₚ of the display module 130, that is, T₀=Tₚ, Step S4026 is executed to maintain the current electrical condition for t seconds. Afterward, Step S201 is executed again, but not limited thereto. In this way, the power applied to the display module 130 may be automatically adjusted to maintain a good display effect of the wearable display device 100 and improve the user experience quality. At the same time, overheating of the display module 130 caused by increasing the power supply of the display module 130 can be prevented, thereby improving the safety of the wearable display device 100.

It is worth mentioning that among Step S4027 to Step S4029, the steps related to the determination of the relative relationship between the temperature represented by the temperature signal and the protection temperature value of the display module 130 to decide whether to increase the power applied to the display module 130 may also be applied to the embodiment shown in FIG. 7. For example, before executing Step S3025 shown in FIG. 7, Step S4027 (shown in FIG. 8) is executed first to sense the temperature (T₀) of the display module 130 to obtain the temperature signal. Next, after Step S4027 (shown in FIG. 8) above, Step S4028 (shown in FIG. 8) is executed to determine whether the temperature T₀ represented by the temperature signal is greater than or equal to the protection temperature value (Tₚ) of the display module 130. When the temperature of the display module 130 is not greater than or equal to the protection temperature value Tₚ of the display module 130, that is, T₀<Tₚ, Step S3025 is executed to increase the power applied to the display module 130 (that is, to increase the brightness of the display light beam). However, the disclosure is not limited thereto. In this way, overheating of the display module 130 when increasing the power supply of the display module 130 can be prevented, thereby improving the safety of the wearable display device 100.

In summary, the wearable display device and the adjustment method thereof according to the embodiments of the disclosure have at least one of the following advantages. In the wearable display device and the adjustment method thereof of the disclosure, the optical sensing module is disposed on a side of the light transmitting element and is configured to sense the intensity of the ambient light passing through the light transmitting element to obtain the light intensity signal. Also, the control unit adjusts the brightness of the display light beam and/or the transmittance of the light transmitting element according to the light intensity signal. In this way, the transmittance of the light transmitting element and/or the power of the display module may be automatically adjusted to maintain a good display effect of the wearable display device and improve the user experience quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An adjustment method of a wearable display device, comprising:
providing a display light beam to a light transmitting element to form an image;
sensing an intensity of an ambient light to obtain a light intensity signal; and
adjusting a brightness of the display light beam and/or a transmittance of the light transmitting element according to the light intensity signal.

2. The adjustment method of the wearable display device according to claim 1, wherein the light transmitting element comprises an electrochromism lens, and the step of adjusting the brightness of the display light beam and/or the transmittance of the light transmitting element according to the light intensity signal further comprises:
adjusting the brightness of the display light beam or a dimming value of the light transmitting element when the light intensity signal is greater than a target range maximum value or less than a target range minimum value.

3. The adjustment method of the wearable display device according to claim 2, wherein the step of adjusting the brightness of the display light beam or the dimming value of the light transmitting element when the light intensity signal is greater than the target range maximum value or less than the target range minimum value further comprises:
determining the dimming value of the light transmitting element when the light intensity signal is greater than the target range maximum value;
increasing the brightness of the display light beam when the dimming value of the light transmitting element is equal to a maximum dimming value of the light transmitting element; and
increasing the dimming value of the light transmitting element when the dimming value of the light transmitting element is less than the maximum dimming value of the light transmitting element.

4. The adjustment method of the wearable display device according to claim 2, wherein the step of adjusting the brightness of the display light beam or the dimming value of the light transmitting element when the light intensity signal is greater than the target range maximum value or less than the target range minimum value further comprises:
determining the dimming value of the light transmitting element when the light intensity signal is less than the target range maximum value;
reducing the brightness of the display light beam when the dimming value of the light transmitting element is equal to a minimum dimming value of the light transmitting element; and
reducing the dimming value of the light transmitting element when the dimming value of the light transmitting element is greater than the minimum dimming value of the light transmitting element.

5. The adjustment method of the wearable display device according to claim 1, wherein the light transmitting element comprises a photochromism lens, and the step of adjusting the brightness of the display light beam and/or the transmittance of the light transmitting element according to the light intensity signal further comprises:
obtaining a target brightness applying power according to the light intensity signal;
reducing a current applying power generating the display light beam when the current applying power is greater than the target brightness applying power; and
sensing a display module providing the display light beam to obtain a temperature signal when the current applying power is less than the target brightness applying power, and adjusting the current applying power according to the temperature signal.

6. The adjustment method of the wearable display device according to claim 5, wherein the step of sensing the display module to obtain the temperature signal when the current applying power is less than the target brightness applying power, and adjusting the current applying power according to the temperature signal further comprises:
increasing the current applying power when a temperature represented by the temperature signal is less than a protection temperature value of the display module.

7. A wearable display device, comprising a frame body, a light transmitting element, a display module, an optical sensing module, and a control unit, wherein:
the light transmitting element is disposed on the frame body;
the display module is disposed on the frame body and is configured to provide a display light beam to the light transmitting element to form an image;
the optical sensing module is disposed on a side of the light transmitting element and is configured to sense an intensity of an ambient light passing through the light transmitting element to obtain a light intensity signal; and
the control unit is electrically connected to the display module and the optical sensing module, and the control unit is configured to adjust a brightness of the display light beam according to the light intensity signal.

8. The wearable display device according to claim 7, wherein the light transmitting element has an image forming area and a sensing light incident area, the display light beam from the display module is transmitted to the image forming area to form the image, the optical sensing module is configured to receive an ambient light passing through the sensing light incident area, and the image forming area and the sensing light incident area do not overlap.

9. The wearable display device according to claim 7, wherein the light transmitting element comprises a photochromism lens.

10. The wearable display device according to claim 9, wherein the wearable display device further comprises a thermal sensing element, the thermal sensing element is disposed on the frame body and electrically connected to the control unit, and is configured to sense a temperature of the display module to obtain a temperature signal, and the control unit is further configured to adjust the brightness of the display light beam according to the temperature signal.

11. The wearable display device according to claim 7, wherein the light transmitting element comprises an electrochromism lens, and the control unit is further configured to adjust a dimming value of the light transmitting element according to the light intensity signal.

12. The wearable display device according to claim 11, wherein the wearable display device further comprises a thermal sensing element, the thermal sensing element is disposed on the frame body and electrically connected to the control unit, and is configured to sense a temperature of the display module to obtain a temperature signal, and the control unit is further configured to adjust the brightness of the display light beam according to the temperature signal.
